(19) United States
(12) Patent Application Publication
(10) Pub. No.: US 2026/0270540 A1
(43) Pub. Date: Sep. 10, 2026

(54) SUBSTRATE FOR LIGHT-SHIELDING PLATE, METAL LIGHT-SHIELDING PLATE, CAMERA MODULE, AND ELECTRONIC DEVICE

(71) Applicant: TOPPAN Holdings Inc., Tokyo (JP)

(72) Inventors: Yoshihiro KOGA, Tokyo (JP); Kazuma USUI, Tokyo (JP); Kaori MATSUGUMA, Tokyo (JP); Akihiko KOBAYASHI, Tokyo (JP)

(73) Assignee: TOPPAN Holdings Inc., Tokyo (JP)

(21) Appl. No.: 19/663,687

(22) Filed: Apr. 30, 2026

Related U.S. Application Data
(63) Continuation of application No. PCT/JP2025/029409, filed on Aug. 21, 2025.

(30) Foreign Application Priority Data
Aug. 23, 2024 (JP) 2024-143375

(51) Int. Cl. H04N 23/55

(52) U.S. Cl. CPC H04N 23/55

(57) ABSTRACT

A substrate for a light-shielding plate used for producing a metal light-shielding plate has a passivation film on a surface thereof, and a thickness of the passivation film is 50 Å or more and 100 Å or less.

### CROSS REFERENCE TO RELATED APPLICATIONS

This application is a continuation application based on PCT International Patent Application No. PCT/JP2025/029409, filed on Aug. 21, 2025, which claims priority to Japanese Patent Application No. 2024-143375, filed on Aug. 23, 2024, in the Japan Patent Office. The contents of both the Japanese Patent Application and the PCT Application are incorporated herein by reference.

### FIELD

The present invention relates to a substrate for a light-shielding plate, and more specifically, to a substrate for a light-shielding plate for producing a light-shielding plate incorporated into a camera module. A metal light-shielding plate, a camera module, and an electronic device using the substrate for a light-shielding plate will also be mentioned.

### BACKGROUND

A member called a light-shielding plate that functions as an aperture for external light is used in a camera module provided in an electronic device such as a smartphone. The light-shielding plate has a through hole penetrating in a plate thickness direction for passing only necessary external light. The light-shielding plate suppresses image defects such as ghosts or flares that occur in an image due to unnecessary external light (for example, scattered light) being incident on a lens or an imaging element (an image sensor such as a CCD or a CMOS).

Japanese Unexamined Patent Application, First Publication No. 2021-113920 discloses a metal light-shielding plate that can obtain a desired light-shielding performance even when formed to be thin. In the production of the metal light-shielding plate, a through hole is formed in a substrate for a light-shielding plate (metal foil). In a case of forming the through hole in the substrate for a light-shielding plate, a resist layer is provided on both surfaces of the substrate for a light-shielding plate, a pattern corresponding to the through hole is formed in each resist layer, and the substrate for a light-shielding plate is etched from both surfaces using the resist layer on which the pattern is formed as a mask. As a result, the through hole can be formed in the substrate for a light-shielding plate.

### SUMMARY

Meanwhile, in a case where the through hole is formed in the substrate for a light-shielding plate by the above-described process, the periphery of the through hole in a plan view is not necessarily smooth, and rattling or variation in an inner diameter dimension may occur. In this case, unnecessary external light is incident on a lens or an imaging element in a camera module, and the light-shielding plate cannot exhibit a predetermined light-shielding performance.

The present inventors have conducted various studies on conditions of a substrate for a light-shielding plate for improving the shape of a through hole. As a result, the present inventors have found that a passivation film present on a surface of the substrate for a light-shielding plate is significantly involved, and have completed the present invention.

In consideration of the above circumstances, an object of the present invention is to provide a substrate for a light-shielding plate in which a through hole having a favorable shape in a plan view is easily formed.

A first aspect of the present invention is a substrate for a light-shielding plate used for producing a metal light-shielding plate.

The substrate for a light-shielding plate has a passivation film on a surface, and a thickness of the passivation film is 50 Å or more and 100 Å or less.

A second aspect of the present invention is a metal light-shielding plate that is composed of a sheet-shaped metal and has a through hole.

The metal light-shielding plate has a passivation film on a surface, and a thickness of the passivation film is 50 Å or more and 100 Å or less.

A third aspect of the present invention is a camera module including the metal light-shielding plate according to the second aspect.

A fourth aspect of the present invention is an electronic device including the camera module according to the third aspect.

According to the present invention, it is possible to provide a substrate for a light-shielding plate in which a through hole having a favorable shape in a plan view is easily formed.

### BRIEF DESCRIPTION OF DRAWINGS

FIG. 1 is a schematic cross-sectional view of a forming portion of a through hole in a substrate used for examination.

FIG. 2 is a plan view photograph of a through hole in the substrate used for examination.

FIG. 3 is A schematic plan view showing a metal light-shielding plate according to an embodiment of the present invention.

FIG. 4 is a schematic diagram showing a camera module using the same metal light-shielding plate.

### DETAILED DESCRIPTION OF THE PREFERRED EMBODIMENTS

An embodiment of the present invention will be described with reference to FIGS. 1 to 4.

The present inventors have conducted various studies on the cause of the fact that the peripheral edge of the through hole in a plan view is not smooth in etching during the formation of the light-shielding plate, and have reached a hypothesis that the variation in the film thickness of the passivation film for each material lot may be one of the causes.

The surface of a metal material such as stainless steel having corrosion resistance is covered with a passivation film which is a dense oxide film composed of an oxide of chromium (Cr). The thickness of the passivation film varies depending on the treatment temperature, the treatment time, and the like of annealing in a metal material manufacturing step, and it is known that the Cr concentration is decreased, the thickness of the passivation film is reduced, and the corrosion resistance is decreased by increasing the treatment temperature or extending the treatment time.

Since the corrosion of the metal is prevented as long as the passivation film covers the surface of the metal, the fact that the passivation film is excessively thick is not a problem from the viewpoint of corrosion resistance.

However, in a case where this metal material is processed by etching, the passivation film hinders the progress of etching, and thus the thickness of the passivation film affects the quality of the final product. The thickness of the passivation film is usually in a range of 10 angstrom (Å) to 100 Å. In general, in a case of SUS304 which is austenitic stainless steel, the thickness of the passivation film is in a range of 30 Å to 50 Å.

That is, even in a case where etching conditions considered to be optimal for the formation of a through hole are set using a metal material having a certain composition, a phenomenon may occur in which the through hole is not formed as intended due to the fact that the same etching conditions are set but the etching behavior is different from that at the time of setting, in a case where the thickness of the passivation film is different even though the composition is the same. As a result, it is difficult to stably produce the light-shielding plate.

Based on the above hypothesis, the present inventors have examined the relationship between the passivation film thickness of various substrates for light-shielding plates and the formation of through holes by etching, and have found a passivation film thickness suitable for etching.

SUS304 is austenitic stainless steel containing chromium as a main element that produces corrosion resistance and nickel as a main component that stabilizes austenite, and is classified as “chromium-nickel based stainless steel”. The mechanical properties and chemical composition of SUS304 are specified in JIS G4303.

In addition to SUS301, SUS303, SUS316, and the like are also austenitic stainless steel.

In this examination, a slab having a thickness of 200 mm, which is composed of an iron-chromium-nickel based alloy containing 19% by mass of a chromium element, 9% by mass of a nickel element, and a remainder of an iron element, is prepared by continuous casting. Next, a steel piece is produced by performing hot forging on the slab.

The steel piece is hot-rolled until the thickness reaches 600 μm to obtain a hot-rolled material. Subsequently, cold rolling and annealing (annealing treatment) are alternately performed twice to obtain a rolled material having a thickness of 30 μm.

In this case, the rolling reduction in the first cold rolling is set to 75% to obtain a rolled material having a thickness of 150 μm. The rolling reduction in the second cold rolling is set to 80% to obtain a rolled material having a thickness of 30 μm. As a result, the total rolling reduction in the rolled material after the two times of cold rolling on the hot-rolled material before the cold rolling is set to 95%.

Thereafter, the rolled material is subjected to tension annealing in an atmosphere of a mixed gas of 0.1% by volume of nitrogen and 99.9% by volume of hydrogen. The annealing temperature in the tension annealing is set to 950° C. to 1050° C., and the holding time is set to 5 seconds to 10 seconds. As a result, a substrate for a light-shielding plate for examination having a thickness of 30 μm is obtained.

In this procedure, seven lots are produced, and the following examinations are performed on each substrate.

### (Measurement of Passivation Film Thickness)

For each of the produced substrates, the passivation film thickness on one surface is measured using XPS analysis. In this examination, the passivation film thickness is calculated based on a point at which the oxygen amount became half of the maximum oxygen amount.

### (Production and Evaluation of Through Hole)

After the measurement of the passivation film thickness, a through hole is formed in the substrate by wet etching with a ferric chloride solution using a resist. The shape of the through hole in the resist is a perfect circle having a diameter of 450 μm, and 216 through holes are formed in each substrate. The through hole is formed by two-stage etching in which etching is performed from one surface, the surface is protected, and then the opposite surface is etched.

FIG. 1 shows a schematic cross-sectional view of a formation portion of the through hole. A through hole 10H includes a first recess 10H1 and a second recess 10H2. The first recess 10H1 is a recess having a first opening HIR on a first surface 10R of the substrate 10 and having a tapered shape from the first surface 10R toward a second surface 10F. The second recess 10H2 has a second opening H2F larger than the first opening HIR on the second surface 10F of the substrate 10. The second recess 10H2 has a tapered shape from the second surface 10F toward the first surface 10R and is connected to the first recess 10H1. Among the openings included in the first recess 10H1, an opening on a side opposite to the first opening HIR is a central opening HC having a circular shape.

In a thickness direction of the substrate 10, a depth dimension of the second recess 10H2 is larger than a depth dimension of the first recess 10H1. In addition, the central opening HC is located near the first opening HIR. The through hole 10H is formed in a tapered shape that decreases from the first surface 10R toward the second surface 10F and from the second surface 10F toward the first surface 10R.

Each formed through hole is imaged from above, and a diameter is calculated by approximation to a perfect circle through image processing.

Table 1 shows production conditions and measurement results of each lot.

TABLE 1

| | Annealing condition | | Passivation | | | | |
|---|---|---|---|---|---|---|---|
| | | Holding | film | Inner diameter of through hole | | | |
| | Temperature | time | thickness | Average | Maximum | Minimum | 3σ |
| | (° C.) | (seconds) | (Å) | (μm) | (μm) | (μm) | (μm) |
| Lot 1 | 980 | 5 | 30 | 450.8 | 457.8 | 445.1 | 5.4 |
| Lot 2 | 960 | 5 | 35 | 450.1 | 456.9 | 444.9 | 5.0 |
| Lot 3 | 970 | 5 | 50 | 449.7 | 452.5 | 447.1 | 2.5 |
| Lot 4 | 970 | 10 | 60 | 450.8 | 452.2 | 449.4 | 1.1 |
| Lot 5 | 1000 | 10 | 80 | 449.5 | 452.3 | 447.1 | 2.0 |
| Lot 6 | 1025 | 5 | 80 | 450.3 | 451.1 | 449.0 | 0.5 |
| Lot 7 | 1050 | 10 | 100 | 450.5 | 451.9 | 448.9 | 1.0 |

As shown in Table 1, the passivation film thicknesses of the respective substrates were significantly different from 30 Å to 100 Å.

Regarding the average value of the inner diameters of the formed through holes, no significant difference was observed in the respective substrates, but in the substrates of lots 1 and 2 having the passivation film thicknesses of 30 Å and 35 Å, respectively, 3σ was more than 5 μm, and the variation was large.

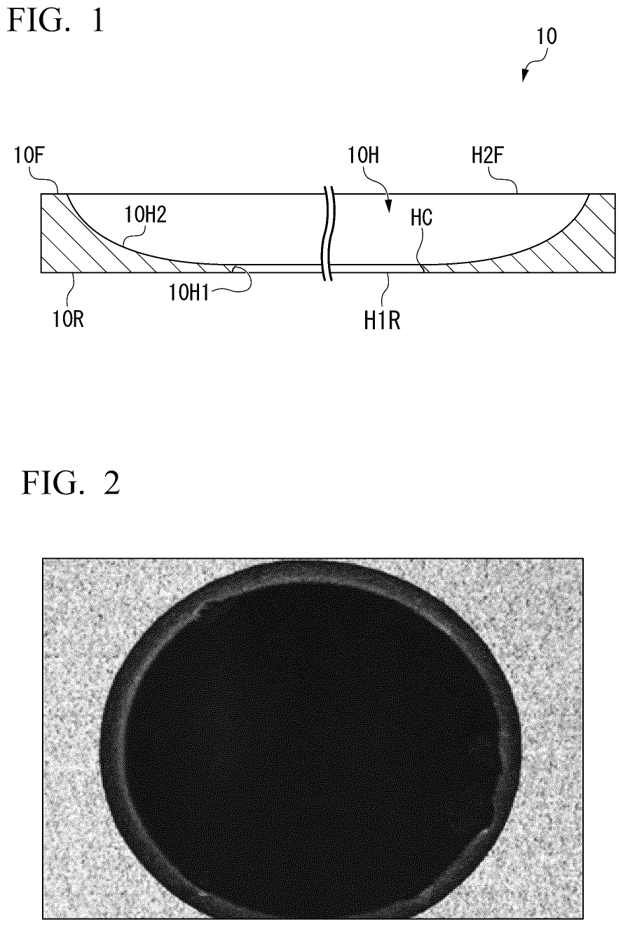

FIG. 2 shows a plan view photograph of the through hole in lot 1. Irregularities, which are believed to be due to pitting corrosion, are observed at a peripheral edge of the through hole, and these are considered to affect an increase in a maximum value and a decrease in a minimum value of inner diameter values of the through hole shown in Table 1.

When the diameter of the through hole formed at the center of the light-shielding plate deviates from the design value by 3 μm or more, the possibility that ghost or flare occurs in the attached camera module or the like reaches an unacceptable range. The deviation of 3 μm or more from the design value is substantially synonymous with the 3σ of 3 or more in Table 1. From this viewpoint, it was considered that the passivation film thickness of the substrate for a light-shielding plate was preferably 50 Å or more. Since the upper limit value of the passivation film thickness in the above-described manufacturing process is approximately 100 Å, it was considered that the passivation film thickness of the substrate for a light-shielding plate was preferably 50 Å or more and 100 Å or less.

In addition, when the passivation film thickness around the through hole of each substrate was measured after forming of the through hole, the value was substantially the same as the value before forming of the through hole. Therefore, it was considered that the passivation film thickness did not basically change before and after etching, and the passivation film thickness in the completed light-shielding plate could be estimated as the passivation film thickness of the substrate for a light-shielding plate used.

From the viewpoint of the dimension of the through hole, it was considered that 36 could be managed to be less than 3 by setting the difference between the minimum value and the maximum value sandwiching the target value (450 μm) to 5.4 μm or less. This is substantially equivalent to 1.2% or less of the target value of the diameter of the through hole and less than 1.3% of the average value of the actually measured through hole diameters.

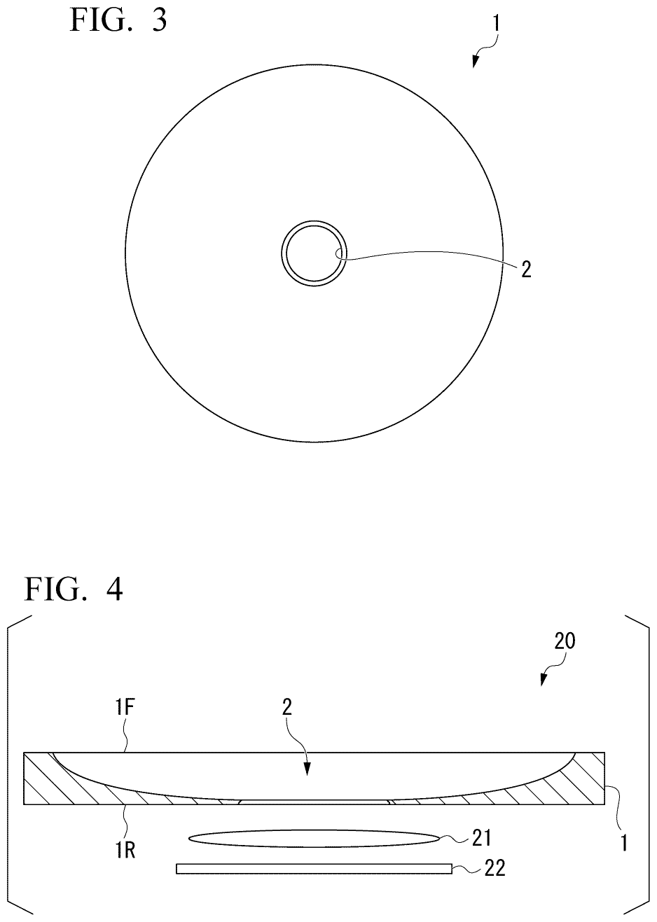

The metal light-shielding plate as shown in FIG. 3 is completed by cutting the substrate for a light-shielding plate on which the through hole is formed. In one example, a metal light-shielding plate 1 is a planar circular member composed of a sheet-shaped metal and has a circular through hole 2 at the center.

The metal light-shielding plate according to the present embodiment is formed using a substrate for a light-shielding plate having a passivation film thickness of 50 Å or more, so that the shape of the through hole is stable. Therefore, even when applied to a camera module for an electronic device such as a smartphone, it is difficult to generate a ghost, a flare, or the like, and it is possible to contribute to the configuration of a high-quality camera module and electronic device.

FIG. 4 shows an example of a camera module. A camera module 20 includes the above-described metal light-shielding plate 1, a lens 21, and an imaging element 22. The lens 21 transmits light that has passed through the through hole 2 of the metal light-shielding plate 1. Light transmitted through the lens 21 is incident on the imaging element 22. The metal light-shielding plate 1 is located on the incident side of light with respect to the lens 21 in a state where a first surface 1R and the lens 21 face each other. The light incident on the lens 21 can be more suitably limited as compared with a case where a second surface 1F of the metal light-shielding plate 1 faces the lens 21.

Although the embodiment of the present invention has been described above, the specific configuration is not limited to the embodiment, and changes in configuration, combinations, and the like within the scope of the present invention are also included.

For example, the material of the substrate for a light-shielding plate according to the present invention is not limited to SUS304 used in the above-described examination, and other austenitic stainless steels such as SUS301, SUS303, and SUS316 can also be used.

In addition, the thickness of the substrate is also not limited to 30 μm in the above-described examination, and may be a different thickness.

### INDUSTRIAL APPLICABILITY

According to the present invention, it is possible to provide a substrate for a light-shielding plate in which a through hole having a favorable shape in a plan view is easily formed.

1. A substrate for a light-shielding plate used for producing a metal light-shielding plate, the substrate having a passivation film on a surface thereof,
wherein a thickness of the passivation film is 50 Å or more and 100 Å or less.

2. The substrate for a light-shielding plate according to claim 1,
wherein the substrate is composed of austenitic stainless steel.

3. The substrate for a light-shielding plate according to claim 2,
wherein the austenitic stainless steel is SUS304 specified in JIS G4303.

4. The substrate for a light-shielding plate according to claim 1,
wherein a plurality of substantially circular through holes are formed by etching, and a difference between a maximum value and a minimum value of a diameter of the through holes is less than 1.3% of an average value of the diameter.

5. A metal light-shielding plate composed of a sheet-shaped metal and having through holes, the metal light-shielding plate having a passivation film on a surface thereof,
wherein a thickness of the passivation film is 50 Å or more and 100 Å or less.

6. A camera module comprising the metal light-shielding plate according to claim 5.

7. An electronic device comprising the camera module according to claim 6.
